(19) United States
(12) Patent Application Publication
(10) Pub. No.: US 2026/0122754 A1
(43) Pub. Date: Apr. 30, 2026

(54) Compact neutron generator based on an all-glass helicon wave ion source

(71) Applicant: HEFEI COMPREHENSIVE NATIONAL SCIENCE CENTER ENERGY RESEARCH INSTITUTE (ANHUI ENERGY LABORATORY), Hefei (CN)

(72) Inventors: Yuzhong QIAN, Hefei (CN); Mengmeng LI, Hefei (CN); Zhenqing ZHU, Hefei (CN); Xin TAO, Hefei (CN); Lizhen LIANG, Hefei (CN); Chundong HU, Hefei (CN)

(73) Assignee: HEFEI COMPREHENSIVE NATIONAL SCIENCE CENTER ENERGY RESEARCH INSTITUTE (ANHUI ENERGY LABORATORY), Hefei (CN)

(21) Appl. No.: 19/134,593

(22) PCT Filed: Apr. 2, 2025
(86) PCT No.: PCT/CN2025/086930

§ 371 Date: May 30, 2025

(30) Foreign Application Priority Data
Oct. 25, 2024 (CN) 202411500117.6

(51) Int. Cl. H05H 3/06; G21B 3/00

(52) U.S. Cl. CPC H05H 3/06; G21B 3/006; H05H 2242/10; H05H 2277/13

(57) ABSTRACT

The present application discloses a compact neutron generator based on an all-glass helicon wave ion source, which belongs to the field of accelerator neutron sources. The neutron generator includes a helicon wave ion source part, a cavity part, and a target part. First, deuterium gas is introduced into the ion source chamber. Then, the deuterium gas is excited by an antenna, thereby generating a helicon wave plasma. Under the constraint of a magnetic field, deuterium ions are first extracted in the form of a beam by the potential difference between an extraction electrode and an ion source cover plate, and then accelerated by the electric field between the extraction electrode and a titanium target. Finally, the deuterium ion beam bombards the titanium target, and a deuterium-deuterium fusion reaction occurs to generate neutrons. At the same time, an arc magnet and a resistor are used to suppress the secondary electrons generated by the target, so as to prevent the secondary electrons from being reversely accelerated and entering the ion source chamber. The present application has the advantages of low energy consumption, a compact structure, high plasma density, autonomous cooling, a good secondary electron suppression effect, high extraction beam intensity, and a high neutron yield.

### TECHNICAL FIELD

The present application belongs to the field of accelerator neutron sources, and in particular to a compact neutron generator based on an all-glass helicon wave ion source.

### BACKGROUND

Deuterium-deuterium neutron generator is a nuclear technology device that uses deuterium nuclear fusion reaction to produce neutrons. It produces high-energy neutrons by accelerating deuterium ions and colliding them with the target material. The technical principles of deuterium-deuterium neutron generator mainly include three aspects: ion source technology, accelerator technology and fusion reaction. Among them, the accelerator neutron source uses an accelerator ion source to generate ions, and uses a high-voltage electric field to accelerate and bombard the target material. After the target material is bombarded by a high-energy proton beam, a deuterium-deuterium fusion reaction will occur, releasing neutrons in the 4π direction. Compared with the radioactive source neutron source that uses radioactive nuclides to produce neutrons, the accelerator neutron source has the advantages of high safety, good controllability and long service life. However, it is still a difficult problem to improve the beam intensity and neutron yield of the neutron generator.

### SUMMARY

In order to solve the above technical problems, the present application provides a compact neutron generator based on an all-glass helicon wave ion source. The device uses an all-glass helicon wave ion source to increase the plasma density, and uses a copper-based solid deuterium self-target. At the same time, magnets and resistors are used to suppress secondary electrons, ensuring that the overall device is compact, simple in structure, and convenient for parts processing. At the same time, it satisfies the requirements of ion beam confinement and secondary electron suppression, thereby obtaining a high-current ion beam and increasing neutron yield.

To achieve the above purpose, the technical solution adopted by the present application is as follows:
a compact neutron generator based on an all-glass helicon wave ion source, the neutron generator comprising an ion source part, a chamber part, a target part and supporting vacuum pumping system, a high-voltage feed system, a radio frequency system, a cooling system and a gas supply system; the ion source part, the chamber part and the target part are connected in sequence from top to bottom.

Among them, the ion source part is used to receive the gas fed by the gas supply system, based on the antenna connected to the matcher of the radio frequency system, and by controlling the radio frequency power, the antenna excites the fed gas to generate spiral wave plasma;
the extraction part is used to introduce the plasma into the chamber part in the form of an ion beam;
the chamber part is used to create a vacuum environment for the ion beam in combination with a matching vacuum pumping system;
the target part is used to concentrate the ion beam in a vacuum environment, and generate neutrons by a deuterium-deuterium fusion reaction through a high-voltage feed system;

The cooling system provides cooling channels for the ion source part and the target part respectively.

Furthermore, the ion source part is fixed by boltingss between the ion source cover plate and the chamber upper cover plate; the ion source chamber is a cylindrical body with an upper round cover capped, a small protruding hollow cylinder and a lower opening; the ion source chamber is fixed by bolting between the glass cover plate and the ion source cover plate; an antenna and a magnet are placed outside the ion source chamber; after the coil is connected to the radio frequency system, the gas inside the ion source chamber is excited to generate helicon wave plasma, and the magnet confines the helicon wave plasma.

Furthermore, the chamber of the chamber part is cylindrical in shape, and the chamber upper cover and the chamber lower cover are connected by bolts. Sealing rings are used between the chamber upper cover and the chamber lower cover and the chamber for vacuum sealing. An exhaust port is provided around the chamber, and a vacuum pumping system is installed at the exhaust port to provide a vacuum environment inside the chamber.

Furthermore, the target part includes a coaxial lead-out electrode, a target, a connecting frame, a target support rod, a target base, etc. The target support rod is fixed to the target base by a fixing screw at the bottom edge, the connecting frame and the target support rod are fixed by bolt connection, the target and the connecting frame are fixed by bolt connection, the lead-out electrode is fixed to the connecting frame by embedding, the target base is connected to the lower cover of the chamber by bolts, a magnet is placed inside the lead-out electrode to suppress secondary electrons, a resistor is placed at the connecting frame to also suppress secondary electrons, and a high-voltage channel is opened inside the target base for the high-voltage feeding system to feed high voltage to the target through a high-voltage feeding line.

Furthermore, the chamber of the chamber part is made of metal, the shape and size of the chamber are determined according to the target diameter and the installation environment, functional ports are opened around the chamber for exhaust, observation and measurement, and flanges are welded at both ends of the chamber.

Furthermore, the chamber upper cover is a flange with a middle opening as a whole. The diameter of the middle opening is larger than the diameter of the lead-out tube head and smaller than the outer diameter of the ion source cover. The chamber upper cover is made of the same material as the chamber of the chamber part.

Furthermore, the ion source chamber is made of non-metallic materials, with a round cover at the top and a protruding hollow cylinder on which a portion of the reaction gas can enter the ion source chamber. The middle portion is a hollow cylinder, and the lower end is a disc that extends outward and has a partial protrusion at the bottom. The shape of the end face is changed according to the sealing method, and the upper and lower surfaces of the lower end are in contact with the glass cover plate and the ion source cover plate respectively.

Furthermore, the ion source chamber is fixed by squeezing the glass cover plate and the ion source cover plate, and the ion source is vacuum-sealed due to the squeezing and deformation of the sealing ring.

Furthermore, the antenna is a Helicon type antenna.

Furthermore, the antenna is made of materials with excellent thermal conductivity and high electrical conductivity, a cooling channel is provided inside the antenna, and the cross section of the antenna is a hollow ring.

Furthermore, the gas is deuterium gas, which is stored in a gas storage container, and the container itself has a gas pressure gauge, a needle valve, and a pressure reducing valve.

Furthermore, an air inlet pipe is provided at the upper end of the ion source chamber, and a gas controller is installed on the air inlet pipe to control the flow rate of deuterium gas released into the ion source chamber and the opening and closing of the gas path.

Furthermore, three centrally symmetrical threaded holes and L-shaped slots are machined on the end surface of the glass cover plate, which are used to screw in the threaded pillars and fix the annular magnet and make it coaxial with the ion source chamber. Two sealing slots are machined on the lower end surface.

Furthermore, the protruding magnet chuck is machined with a circular hole for passing through the ion source chamber, and three through holes corresponding to the three threaded holes of the glass cover are machined at the edge. One end face has a raised circular ring for fixing the antenna and making the antenna and the ion source chamber coaxial, and the other end face has an L-shaped slot for fixing the annular magnet and making it coaxial with the ion source chamber.

Furthermore, a circular hole is machined in the center of the planar magnet chuck for passing through the ion source chamber, three through holes are machined at the edge corresponding to the three threaded holes of the glass cover, an L-shaped slot is machined on one end surface for fixing the magnet and making it coaxial with the ion source chamber, and the other end surface is a plane.

Furthermore, the ion source cover is made of a metal material with good thermal conductivity, has a disc shape, and has a straight ion beam extraction hole at the center, which acts as a plasma electrode and forms a vacuum seal through a sealing ring between the cover and the chamber.

Furthermore, a hollow annular cooling channel is provided inside the ion source cover plate, and a protruding cylindrical internal threaded hole is welded on the upper end surface.

Furthermore, the ion source part, the threaded support, the nut, the glass cover, the bolt, the protruding magnet chuck, and the planar magnet chuck are made of PEEK material.

Furthermore, the target base and the lower cover plate of the chamber are fixed by bolt connection.

Furthermore, the target base is made of insulating material, and is generally a small concave hollow cylinder at the upper end, a large cylinder at the lower end, and a convex disc edge at the junction of the upper and lower ends. There are 12 through holes on the convex disc edge and an L-shaped circular channel inside.

Furthermore, a high-pressure feed-in channel is machined on the lower end surface of the target base. The high-pressure channel is cylindrical as a whole and has an internal thread at the lower end.

Furthermore, the high-pressure sealing pipe as a whole is cylindrical at both ends and a regular hexagonal flat plate in the middle. The outside of the cylinder is threaded, the upper cylinder is machined with a cylindrical hole, and the lower cylinder is machined with a conical hole; the high-pressure sealing cover as a whole is a regular hexagon on the outside, a hollow internally threaded cylinder on the inside, and a circular hole on the end face; a circular through hole is provided in the middle of the conical rubber plug.

Furthermore, the target support rod is cylindrical as a whole, has a protruding edge at the lower end, and is provided with a circular through channel inside. The protruding edge has circumferentially distributed through holes, and the upper end surface has circumferentially distributed threaded holes. The target support rod is fixed to the target base by screw connections, and the lower end surface has threaded holes.

Furthermore, the high-pressure sealing tube is fastened to the target base through threads, the high-pressure wire is inserted into the high-pressure feed-in channel, the head wire of the high-pressure wire is fixed through the connection between the threaded holes on the lower end surface of the bolt target support rod, and then fixed to the target base with the help of the radial force of the conical rubber plug and the axial force of the high-pressure sealing cover, and a sealing slot is provided on the side of the high-pressure sealing pipe that contacts the target base.

Furthermore, the upper and lower ends of the connecting frame are disc-shaped, both of which are machined with circumferentially distributed through holes. The middle part is a rectangular parallelepiped with rounded corners and has two circular through channels inside. The connecting frame is fixed to the target support rod by screw connection.

Furthermore, the lower shielding cover as a whole is an L-shaped cylinder with a through opening at the lower end and an inwardly extending upper end, and the upper end is provided with circumferentially distributed through holes, and the lower shielding cover is fixed to the lower end of the connecting frame by bolts; the upper shielding cover as a whole is a through opening at the lower end, and the upper end extends outward with an L-shaped outer edge, and the upper end is provided with circumferentially distributed through holes, and the upper shielding cover is fixed to the upper end of the connecting frame by bolts.

Furthermore, the resistance elements are fixed by bolts between the upper and lower ends of the connecting frame.

Furthermore, the target is based on oxygen-free copper and has a coating on the surface, wherein the coating is a titanium film, and the coating area and thickness are set according to ion beam and neutron parameters.

Furthermore, the target and the connecting frame are fixed by bolt connection.

Furthermore, the high-voltage sealing cover and the high-voltage sealing tube are made of insulating material and are used to press the high-voltage feed line onto the target support.

Furthermore, the lead-out electrode is divided into two parts, the lead-out electrode head and the lead-out electrode straight cylinder, the two parts are matched and fixed by a slot, the lead-out electrode head is provided with a circular hole, and an inner concave ring is provided inside the upper end of the lead-out electrode straight cylinder.

Furthermore, the magnet bracket is fixed by being placed on the concave circular ring inside the lead-out electrode straight cylinder, and the magnet bracket is provided with two symmetrical square holes.

Furthermore, the magnet box is a rectangular parallelepiped with a hollow interior and no cover on the upper part, and the upper part has a protruding frame, and the magnet box cover is a rectangular parallelepiped with no upper cover plate and a hollow interior.

Furthermore, the lead-out electrode straight cylinder is fixedly matched with the target support rod through a slot.

Furthermore, the annular magnet is made of NdFeB or SmCo, the core provides a 1.1 T magnetic field, and the upper and lower end surfaces are magnetized surfaces; the rectangular magnet is made of NdFeB or SmCo, the core provides a 1.1 T magnetic field, and the two largest rectangular surfaces are magnetized surfaces.

Furthermore, the target part, the target support rod, the connecting frame, the target body, and the lead-out electrode are all made of materials with good conductive effects, and the high-voltage sealing cover and the high-voltage sealing tube are made of insulating materials.

Furthermore, a 90 kV high voltage is applied to the target support rod, and the high voltage is further transmitted to the target and the extraction electrode. The potential on the target and the extraction electrode is 90 kV. There is no high voltage on the ion source cover (plasma electrode), and the potential is 0. An electric field is generated between the extraction electrode, the target and the ion source cover (plasma electrode), and the ion beam is drawn into the chamber and bombards the target.

Furthermore, an inclined fluorinated liquid inlet channel and a horizontal fluorinated liquid outflow channel are opened on the side of the high-pressure channel.

Furthermore, the ion source partial cooling system includes antenna and ion source cover cooling.

Furthermore, the target partial cooling system has target cooling, the coolant enters through the coolant inlet channel, flows out through the coolant outflow channel, flows through the target base, the target support rod, the connecting frame and the target, and the channels between the target base and the target support rod, the target support rod and the connecting frame, and the connecting frame and the target are water-sealed by sealing rings to prevent the coolant from leaking.

Furthermore, the resistivity of the coolant is greater than or equal to 4 MΩ·cm, ensuring that the target surface temperature is less than 120° C. and the overall temperature of the coil is less than 50° C. The coolant is pumped into the cooling part through a cooler, and the coolant pressure, flow rate and temperature are set by the cooler.

Furthermore, the sealing ring is made of fluororubber and has a circular or rectangular cross-section, which is placed in the sealing slot and fills the sealing slot to form a vacuum seal after being squeezed under pressure. A cooling circulation channel is set between the ion source chamber and the plasma water-cooling cover to achieve cooling of the ion source upper and lower cover plates, the ion source chamber and the coil.

The beneficial effects of the present application are:
1. The present application adopts an all-glass spiral wave ion source and uses a copper-based solid deuterium self-target. It can not only ensure that the overall device is compact, low in energy consumption, and simple in structure, but also increase the plasma density, thereby obtaining a high-current ion beam and increasing the neutron yield;
2. The present application adopts a combination of magnets and resistors to suppress secondary electrons, which greatly enhances the effect of secondary electron suppression;
3. The present application can draw a beam current of 10 mA under a high voltage of 90 kV, and the neutron yield can reach more than 2 E9 n/s;
4. The present application adopts a common sealing method, a convenient quick-plug connector, and a convenient threaded connection as a whole, which can be easily assembled and replaced with later parts, reducing production and use costs and facilitating commercialization.

### DESCRIPTION OF THE DRAWINGS

FIG. 1 is a cross-sectional schematic view of a compact neutron generator based on an all-glass helicon wave ion source of the present application;

FIG. 2 is a schematic view of the assembly of the ion source part;

FIG. 3 is a partial cross-sectional view of the ion source;

FIG. 4 is a schematic view of the antenna;

FIG. 5 is a schematic view of the chamber;

FIG. 6 is a first partial cross-sectional view of the target body;

FIG. 7 is a schematic view of the fixed assembly of the rectangular magnet;

FIG. 8 is a second partial cross-sectional view of the target;

FIG. 9 is a third partial cross-sectional view of the target;

FIG. 10 is a cross-sectional view of the connection frame, target and shielding cover;

FIG. 11 is a fourth partial cross-sectional view of the target.

In the figures: 1. ion source part; 2. chamber part; 3. target part; 101. inlet pipe; 102. flow meter; 103. quartz tube sleeve; 104. threaded pillar; 105.flat magnet chuck; 106. ion source chamber; 107. antenna; 108. glass cover plate; 109. ion source cover plate; 110. protruding magnet chuck; 111. annular magnet; 201. chamber upper cover plate; 202. chamber; 203.chamber lower cover plate; 204. molecular pump; 301. lead-out electrode head; 302. Magnet bracket; 303. rectangular magnet; 304. upper shield; 305. lead-out electrode straight cylinder; 306. target; 307. resistor element; 308. connecting frame; 309. high-pressure sealing tube; 310. high-pressure sealing cover; 311. conical rubber plug; 312. a target base; 313. target body support rod; 314. lower shielding cover; 315. magnetic box cover; 316. magnet box; 317. coolant inflow channel; 318. coolant outflow channel; 319. fluorinated liquid inflow channel; 320. fluoride liquid outflow channel.

### DETAILED DESCRIPTION

The present application is described in detail below in conjunction with the embodiments shown in the accompanying drawings:

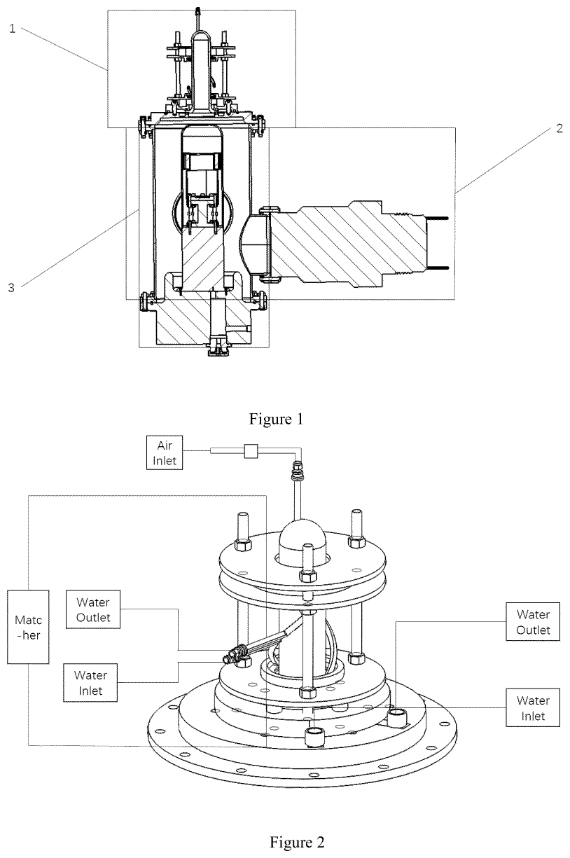

As shown in FIG. 1, the present application provides a compact neutron generator based on an all-glass helicon wave ion source, which is mainly divided from top to bottom into an ion source part 1, a chamber part 2, a target part 3, and its supporting vacuum pumping system, high-voltage feed system, radio frequency system, cooling system and gas supply system; its working principle is: first, the gas supply system introduces the reaction gas into the ion source, and then the ion source ionizes the gas through the radio frequency system to generate an ion beam flow, and the ion beam is led into the chamber by the suspended potential carried by the extraction electrode, and finally the target part accelerates and constrains the ion beam with the help of the accelerating electrode and the high voltage on the target, and then bombards the target, causing a deuterium-deuterium fusion reaction to produce neutrons.

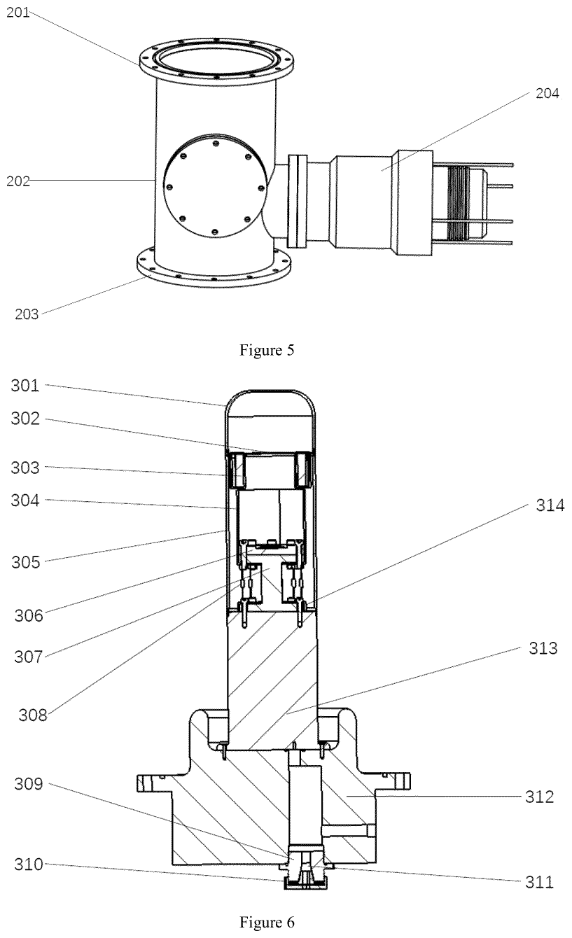

Referring to FIG. 1 and FIG. 5, the main body of the neutron generator is a cylindrical chamber 202, and the upper and lower ends of the chamber 202 are respectively connected to the chamber upper cover 201 and the chamber lower cover 203 by bolts and vacuum-sealed by a sealing ring. The chamber 202 is provided with an air extraction port, which is sealed with a copper ring and connected to the molecular pump 204 by bolts.

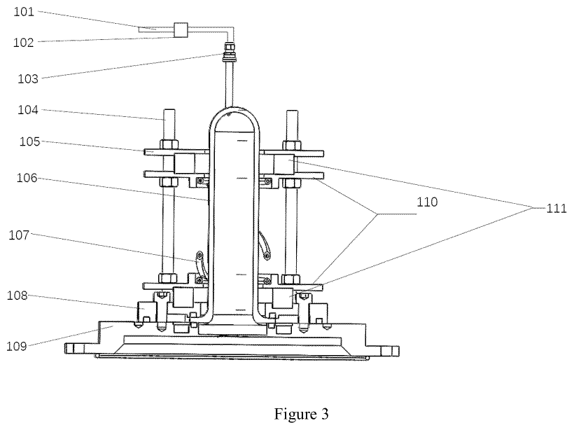

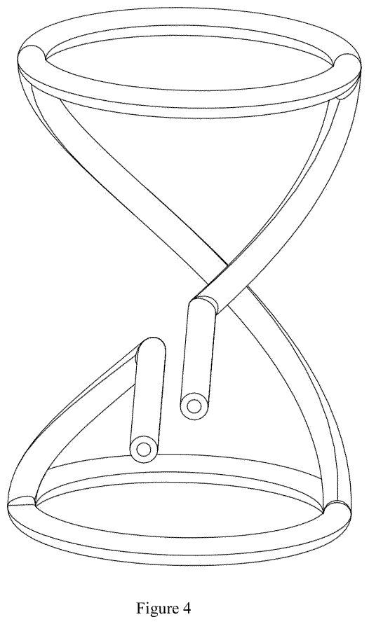

Referring to FIG. 1, FIG. 2, FIG. 3 and FIG. 4, the upper end of the ion source chamber 106 is capped with a round cover and a section of hollow cylinder protruding, on which a reaction gas can enter the ion source chamber 106 from here, the middle part is a hollow cylinder, the lower end is a disc that extends outward and has a part of protrusion at the lower part, and the end face shape is changed according to the sealing method. The gas is sent in by the gas supply system with the help of an air inlet pipe 101, and a flow meter 102 is connected to the air inlet pipe 101, and the air intake amount is controlled by the flow meter 102. The air inlet pipe 101 and the ion source chamber 106 are connected by a quartz tube sleeve 103. The two sides of the protruding disc at the lower end of the ion source chamber 106 are squeezed by a glass cover plate 108 and an ion source cover plate 109, and the squeezing force comes from the bolt connection between the fixed glass cover plate 108 and the ion source cover plate 109, and the glass cover plate 108 and the ion source cover plate 109 are sealed at the contact point with the ion source chamber 106 using a sealing ring. One of the annular magnets 111 is placed in the slot on the upper end surface of the glass cover plate 108, and is fixed on the upper side by a protruding magnet chuck 110 and a threaded support 104 and a matching nut. The other annular magnet is fixed by a threaded support 104, a protruding magnet chuck 110 and a planar magnet chuck 105 and a matching nut. The antenna 107 is fixed by two protruding magnet chucks, and the cooling liquid inlet and outlet of the antenna 107 are equipped with a quartz tube sleeve 103 for inserting a water pipe and passing the cooling liquid. An annular cooling liquid channel is formed inside the ion source cover plate 109, and a protruding internal threaded ring is welded on the upper end surface, on which a quick-connect plug is assembled for inserting a water pipe and passing the cooling liquid.

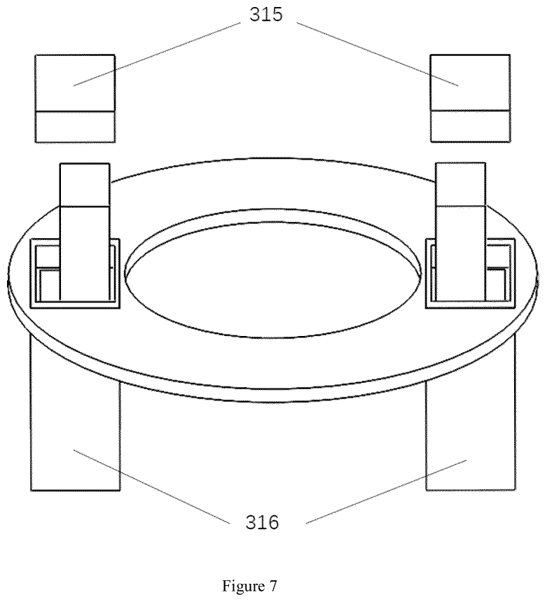

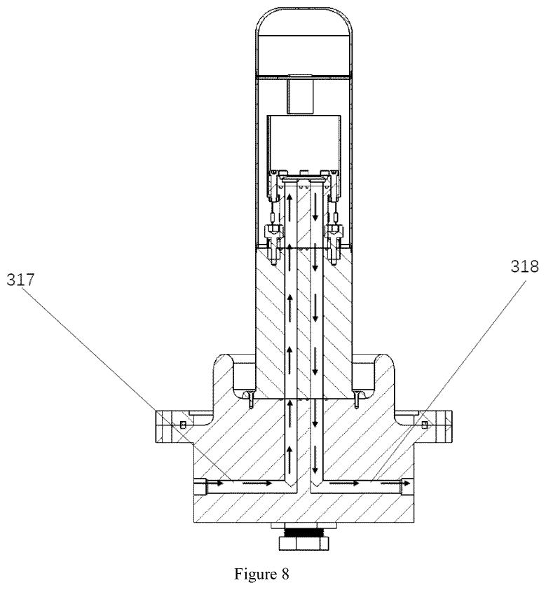

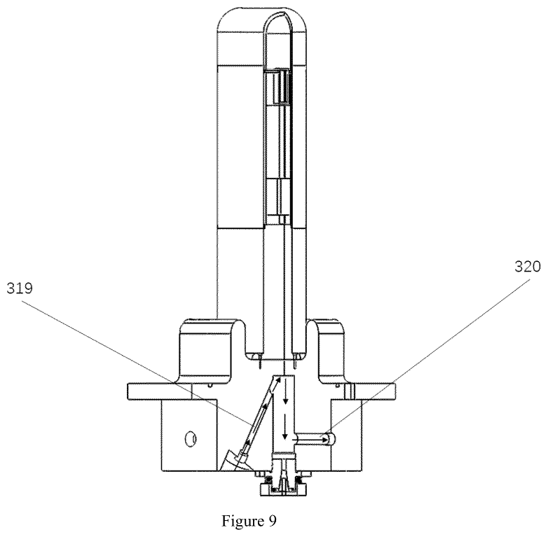

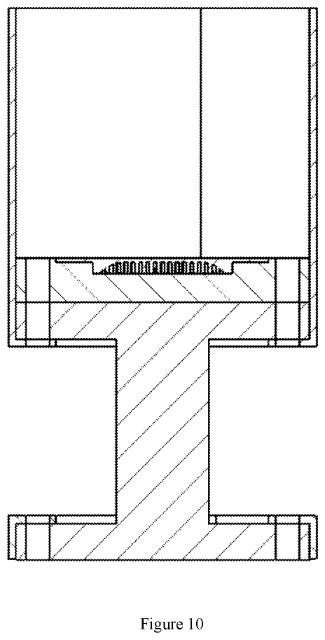

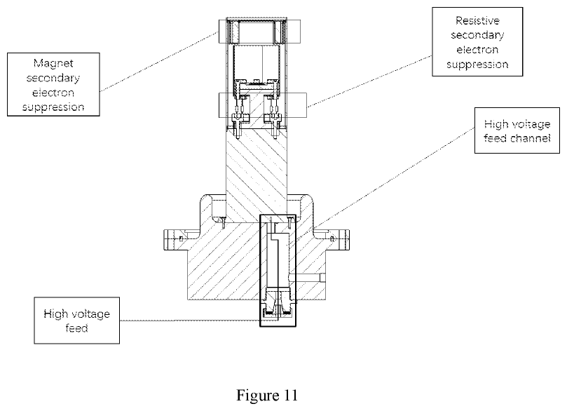

Referring to FIG. 1, FIG. 6, FIG. 7, FIG. 8, FIG. 9, FIG. 10 and FIG. 11, the target part 3 is composed of a target base 312, a target body support rod 313, a connecting frame 308, a target 306, an extraction electrode and the like. The extraction electrode is divided into two parts, the upper part is the extraction electrode head 301, and the lower part is the extraction electrode cylinder 305, and the two parts are clamped and fixed by a slot. The extraction electrode and the target body support rod 313 are clamped and fixed by the slot. The rectangular magnet 303 is fixed to the extraction electrode cylinder 305 by the magnet holder 302, and the magnet holder 302 is fixed by contacting the convex circular ring inside the extraction electrode cylinder 305. The rectangular magnet 303 is placed in the magnet box 316, and then covered with the magnet box cover 315, and the magnet box 316 is fixed by contacting the edge of the rectangular hole of the magnet holder 302 with its outer convex edge. The connecting frame 308 is fixed to the target support rod 313 through the through hole at the bottom edge thereof by bolt connection, and the target 306 is fixed to the connecting frame 308 through the through hole at the edge thereof by bolt connection. The upper shielding cover 304 is fixed by fixing bolts with the connecting frame 308 and the target 306, the lower shielding cover 314 is fixed by fixing bolts with the connecting frame 308 and the target support rod 313, and the resistor element 307 is fixed by fixing bolts with the connecting frame 308, the target 306 and the target support rod 313. The target support rod 313 is fixed to the target base 312 through the through hole at the gas edge by screw connection. The target base 312 and the lower cover plate 203 of the chamber are fixed by bolt connection. The high-pressure sealing tube 309 is screwed into the target base 312 through its external thread and fixed in a threaded connection manner. The high-pressure wire is inserted into the high-pressure sealing cover 310 and the conical rubber plug 311. The head of the high-pressure wire is fixed to the target support rod 313 by bolt connection. The high-pressure sealing cover 310 is screwed on the high-pressure sealing tube 309, so that the high-pressure wire is fixed to the target base 312 by the radial force of the conical rubber plug 311 and the axial force of the high-pressure sealing cover 310. A stepped channel is formed inside the target base 312, and an inclined fluoride liquid inflow channel 319 and a horizontal fluoride liquid outflow channel 320 are formed on both sides of the channel. Two L-shaped channels are formed inside the target base 312, which together with the internal channels between the target support rod 313, the connecting frame 308 and the target 306 constitute a coolant inlet channel 317 and a coolant outlet channel 318. The contact surfaces between the target base 312, the target support rod 313, the connecting frame 308 and the target 306 are sealed with sealing rings to prevent coolant leakage.

Preferably, the chamber 202 is made of metal with certain strength and good processing performance such as SUS304/SUS316/aluminum, and the chamber 202 can withstand pressure changes and has a small leakage rate. The chamber 202 is provided with a suction port, an observation port, and a measurement port as required. The functional ports provided on the chamber 202 and the flange specifications at both ends refer to GB/T 6070-2007 and GB/T 6071-2003. The diameter of the chamber 202 can be changed according to the target diameter and the installation environment. In the embodiment, the diameter is 250 mm and the length is 472 mm.

Preferably, the vacuum system is composed of a molecular pump 204 and a chamber 202, and the air in the chamber 202 is pumped out by the molecular pump 204, thereby achieving a vacuum environment.

Preferably, the chamber upper cover plate 201 is made of the same material as the chamber 202, and is a flange with a central opening, and the flange specifications refer to GB/T 6070-2007. The diameter of the central through hole should be much larger than the diameter of the extraction electrode head 301 and smaller than the outer diameter of the ion source cover plate 109, which is 250 mm in the embodiment.

Preferably, the ion source chamber 106 is made of non-metallic materials, such as quartz glass and boron nitride. The inner diameter of the ion source chamber 106 is 40 mm, and the wall thickness should not be too thick under the conditions of meeting the pressure bearing and sealing properties. In this example, the wall thickness is 5 mm.

Preferably, the cross-sectional outer diameter of the antenna 107 is 6 mm and the inner diameter is 3 mm. The antenna 107 is a helicon type. The antenna diameter and height affect the electron density of the excited plasma and can be adjusted according to the required ion beam performance and the diameter of the chamber 202. The antenna 107 should be made of a material with excellent thermal conductivity and high electrical conductivity, and in the embodiment, the material is copper.

Preferably, the radio frequency system is connected to the antenna 107 via a matcher, and the radio frequency power is adjusted via a radio frequency power supply.

Preferably, in the gas supply system, the gas introduced into the gas inlet pipe 101 is deuterium gas, which is stored in a gas storage bottle and flows into the ion source chamber 106 through the gas inlet pipe 101.

Preferably, the flow meter 102 is installed on the air inlet pipe 101 to control the flow rate of the hydrogen isotope gas released into the ion source chamber 106, and the flow rate in this example is 15 SCCM.

Preferably, the upper end surface of the glass cover plate 108 is machined with three centrally symmetrical threaded holes and an L-shaped slot, which are used to screw in the threaded support 104 and fix the annular magnet 111 and make it coaxial with the ion source chamber 106, and the lower end surface is machined with two sealing slots for sealing the vacuum.

Preferably, the protruding magnet chuck 110 is machined with a circular hole for passing through the ion source chamber 106, and three through holes corresponding to the three threaded holes of the glass cover 108 are machined at the edge. One end face has a raised circular ring for fixing the antenna 107 and making the antenna 107 and the ion source chamber 106 coaxial, and the other end face has an L-shaped groove for fixing the annular magnet 111 and making it coaxial with the ion source chamber 106.

Preferably, a circular hole is machined in the center of the planar magnet chuck 105 for passing the ion source chamber 106, three through holes are machined at the edge corresponding to the three threaded holes of the glass cover 108, an L-shaped slot is machined on one end face for fixing the annular magnet 111 and making it coaxial with the ion source chamber 106, and the other end face is a plane.

Preferably, the ion source cover plate 109 is made of 304 stainless steel material and has a disc shape. A straight ion beam extraction hole with a diameter of 6 mm is opened in the center, which acts as a plasma electrode. A vacuum seal is formed by sealing with the sealing ring between the chamber upper cover plate 201. A hollow annular cooling channel is provided inside the ion source cover plate 109. The cross-section of the cooling channel is a rectangle of 8 mm×15 mm, and a protruding cylindrical internal threaded hole is welded on the upper end face.

Preferably, the ion source part 1, the threaded support 104, the nut, the glass cover 108, the bolt, the protruding magnet chuck 110, and the planar magnet chuck 105 are made of PEEK material.

Preferably, the target base 312 is made of polyformaldehyde material, and is generally a small concave hollow cylinder at the upper end, a large cylinder at the lower end, and a convex disc edge at the junction of the upper and lower ends. The convex disc edge has 12 through holes and an L-shaped circular channel is provided inside.

Preferably, a high-pressure feed-in channel is machined on the lower end surface of the target base 312, and the high-pressure channel is cylindrical as a whole and has an internal thread at the lower end.

Preferably, the high-pressure sealing tube 309 is a whole with cylinders at both ends and a regular hexagonal flat plate in the middle, the outside of the cylinder is threaded, the upper cylinder is machined with a cylindrical hole, and the lower cylinder is machined with a conical hole; the high-pressure sealing cover 310 is a whole with a regular hexagonal outside and a hollow internally threaded cylinder inside, and a circular hole is machined on the end face; the conical rubber plug 311 is provided with a circular through hole in the middle, with a diameter of 8.8 mm.

Preferably, the target support rod 313 is cylindrical as a whole, has a protruding edge at the lower end, and is provided with a circular through channel inside. The protruding edge has circumferentially distributed through holes, and the upper end surface has circumferentially distributed threaded holes. The target support rod 313 is fixed to the target base 312 by screw connections, and the lower end surface has threaded holes.

Preferably, the high-pressure sealing tube 309 is fastened to the target base 312 through threads, the high-pressure wire is inserted into the high-pressure feed-in channel, the head wire of the high-pressure wire is fixed through the connection between the threaded holes on the lower end surface of the bolt target support rod 313, and then fixed to the target base 312 with the help of the radial force of the conical rubber plug 311 and the axial force of the high-pressure sealing cover 310, and a sealing slot is provided on the side of the high-pressure sealing pipe that contacts the target base 312.

Preferably, the upper and lower ends of the connecting frame 308 are disc-shaped, both of which are machined with circumferentially distributed through holes. The middle part is a rectangular parallelepiped with rounded corners and has two circular through channels inside. The connecting frame 308 is fixed to the target support rod 313 by screw connection.

Preferably, the lower shielding cover 314 as a whole is an L-shaped cylinder with a through opening at the lower end and an inwardly extending upper end, and the upper end is provided with circumferentially distributed through holes, and the lower shielding cover 314 is fixed to the lower end of the connecting frame 308 by bolts; the upper shielding cover as a whole is a through opening at the lower end, and the upper end extends outward with an L-shaped outer edge, and the upper end is provided with circumferentially distributed through holes, and the upper shielding cover 304 is fixed to the upper end of the connecting frame by bolts.

Preferably, the resistance element 307 is fixed by bolts between the upper and lower ends of the connecting frame 308, The resistor element 307 is a resistor with a resistance value of 601 kΩ, and the number of the resistor elements 307 is 12.

Preferably, the target 306 is based on oxygen-free copper and has a coating on the surface, wherein the coating is a titanium film, and the coating diameter is 58 mm and the coating thickness is 10 um.

Preferably, the high-pressure sealing cover 310 and the high-pressure sealing tube 309 are made of peek material and are used to press the high-pressure feed line onto the target support rod.

Preferably, the lead-out electrode is divided into two parts, the lead-out electrode head 301 and the lead-out electrode straight cylinder 305, the two parts are matched and fixed by a slot, the lead-out electrode head is provided with a circular hole, and an inner concave ring is provided inside the upper end of the lead-out electrode straight cylinder.

Preferably, the magnet bracket 302 is fixed by being placed on the concave circular ring inside the lead-out electrode straight cylinder 305, and the magnet bracket is provided with two symmetrical square holes.

Preferably, the magnet box 316 is a rectangular parallelepiped with a hollow interior and no cover on the upper part, and the upper part has a protruding frame, and the magnet box cover 315 is a rectangular parallelepiped with no upper cover plate and a hollow interior.

Preferably, the annular magnet 111 is made of NdFeB or SmCo, the core provides a 1.1 T magnetic field, and the upper and lower end surfaces are magnetized surfaces; the magnetic field at the center of the ion source chamber 106 is 400 Gs; the rectangular magnet is made of NdFeB or SmCo, the core provides a 1.1 T magnetic field, and the two largest rectangular surfaces are magnetized surfaces, the magnetic field at the center of the lead-out electrode cylinder 305 is 30 Gs.

Preferably, the target part 3, the target support rod 313, the connecting frame 308, the target 306, and the lead-out electrode are all are made of 304 stainless steel.

Preferably, a 90 kV high voltage is applied to the target support rod 313, and the high voltage is further transmitted to the target 306 and the extraction electrode. The potential on the target and the extraction electrode is 90 kV. There is no high voltage on the ion source cover 109 (plasma electrode), and the potential is 0. An electric field is generated between the extraction electrode, the target 306 and the ion source cover 109 (plasma electrode), and the ion beam is drawn into the chamber and bombards the target.

Preferably, an inclined fluorinated liquid inlet channel 319 and a horizontal fluorinated liquid outflow channel 320 are opened on the side of the high-pressure channel. The high-voltage wire is immersed in flowing fluorinated liquid to achieve high-voltage arc extinguishing to prevent sparking. In this example, the cooling liquid speed at the inlet of the fluorinated liquid channel is 15 L/min.

Preferably, the cooling system of the ion source part 1 includes cooling of the antenna 107 and the ion source cover plate 109. In this example, the cooling liquid velocity at the inlet of the cooling liquid channel is 15 L/min.

Preferably, the target body partial cooling system includes target cooling, the coolant enters through the coolant inlet channel 317, flows out through the coolant outflow channel 318, flows through the target base 312, the target body support column 313, the connecting frame 308 and the target 306, the channels between the target base 312 and the target body support column 313, the target body support column 313 and the connecting frame 308, and the connecting frame 308 and the target 306 are water-sealed by sealing rings to prevent the coolant from leaking. In the present embodiment, the coolant speed at the inlet of the coolant channel is 15 L/min.

Preferably, the coolant is deionized water, and its resistivity should be greater than or equal to 16, to ensure that the surface temperature of the target 306 is less than 120° C. and the overall temperature of the antenna 107 is less than 50° C. The coolant is pumped into the cooling part by a cooler, and the coolant pressure, flow rate, and temperature can be set by the cooler.

Preferably, he sealing ring is made of fluororubber and has a circular or rectangular cross section. It is placed in the sealing groove and fills the sealing groove to form a vacuum seal after being squeezed by pressure.

In summary, the present application sets up a helicon wave ion source based on all glass. The traditional stainless steel ion source upper cover plate and the ion source chamber 106 with double-ended through holes are eliminated, and a new ion source chamber with a through hole at one end and a gas supply system at the other end is adopted. The glass cover plate 108 made of PEEK material and the ion source cover plate 109 made of metal material are pressed against each other to fix the ion source chamber 106, eliminating the capacitance at both ends of the ion source chamber 106, making radio frequency matching easier.

The target part 3 is provided with magnets and resistors to achieve double suppression of secondary electrons, thus enhancing the suppression effect of secondary electrons.

The ion source part 1 and the target part 3 are provided with active cooling systems.

The high-voltage channel is set with insulation conditions. The high-voltage wire is immersed in flowing fluorinated liquid to achieve insulation conditions.

The present application has the advantages of low energy consumption, compact structure, high plasma density, good secondary electron suppression effect, high beam intensity, and high neutron yield. At the same time, the device as a whole adopts simple thread matching and quick connectors to connect the components, which is convenient for assembly and later maintenance, reducing production and use costs.

The specific embodiments described above further illustrate the objectives, technical solutions and beneficial effects of the present application in detail. It should be understood that the above description is only a specific embodiment of the present application and is not intended to limit the present application. Any modifications, equivalent substitutions, improvements, etc. made within the spirit and principles of the present application should be included in the scope of protection of the present application.

1. A compact neutron generator based on an all-glass helicon wave ion source, wherein comprising an ion source part, a chamber part and a target part; the ion source part, the chamber part and the target part are connected in sequence from top to bottom;
the ion source part is used to receive the fed gas, and an antenna is used to excite the fed gas to generate spiral wave plasma by controlling the radio frequency power; the ion source part is fixed by bolting between an ion source cover plate and a chamber upper cover plate, an ion source chamber is a cylindrical body with an upper round cover capping, a small protruding hollow cylinder and a lower opening, the ion source chamber is fixed by boltings between a glass cover plate and the ion source cover plate, and the antenna and a magnet are placed outside the ion source chamber;
the chamber part is used to create a vacuum environment for the ion beam; a chamber of the chamber part is cylindrical in shape, and the chamber upper cover plate and a lower cover plate of connected by bolts, the chamber upper cover plate, the chamber lower cover plate and the chamber are vacuum-sealed by sealing rings, and a vacuum port is provided around the chamber, and a vacuum pumping system is installed at the vacuum port;
the target body part is used to extract the plasma inside the ion source chamber and concentrate the ion beam in the vacuum environment, so as to cause a deuterium-deuterium fusion reaction to produce neutrons, the target body part includes a coaxial extraction electrode, a target, a connecting frame, a target body support rod and a target base, the target body support rod is fixed to the target base by a fixing screw at the bottom edge, the connecting frame and the target body support rods are fixed by bolts, the target and the connecting frame are fixed by bolts, the extraction electrode is fixed to the connecting frame by embedding, the target base is connected to the lower cover of the chamber by bolts, a magnet is placed inside the extraction electrode, a resistor is placed at the connecting frame, and a high-voltage channel is opened inside the target base;
wherein the gas is deuterium gas, which is stored in a gas storage container, and the gas storage container has a gas pressure gauge, a needle valve, and a pressure reducing valve;
wherein a lead-out electrode is divided into two parts, a lead-out electrode head and a lead-out electrode straight cylinder, the two parts are matched and fixed through a slot, the lead-out electrode head is provided with a circular hole, and an inner concave ring is provided inside an upper end of the lead-out electrode straight cylinder;
wherein a target support rod is connected to high voltage, which is further transmitted to the target and the extraction electrode, an electric field is generated between an extraction electrode and the target and the ion source cover electrode, which draws an ion beam into the chamber and bombards the target.

2. (canceled)

3. The compact neutron generator based on an all-glass helicon wave ion source according to claim 1, wherein the upper end surface of the glass cover is machined with three centrally symmetrical threaded holes and L-shaped slots, which are used to screw in the threaded pillars and fix the magnets and make them coaxial with the ion source chamber, the lower end surface is machined with two sealing slots.

4. The compact neutron generator based on an all-glass helicon wave ion source according to claim 1, wherein functional ports are set around the chamber body for exhaust, observation and measurement, and flanges are welded at both ends of the chamber.

5. The compact neutron generator based on an all-glass helicon wave ion source according to claim 1, wherein an upper and an lower end of the connecting frame are disc-shaped, both of which are machined with circumferentially distributed through holes, an middle part is a rectangular parallelepiped with rounded corners and has two circular through channels inside, the connecting frame is fixed to the target support rod by screws.

6. The compact neutron generator based on an all-glass helicon wave ion source according to claim 1, wherein a lower shielding cover is an L-shaped cylinder with a through opening at the lower end and an inwardly extending upper end, and an upper end is provided with through holes distributed circumferentially, the lower shielding cover is fixed to the lower end of the connecting frame by bolts; an upper shielding cover as a whole is a through opening at the lower end, and the upper end extends outward in an L-shaped outer edge, and the upper end is provided with through holes distributed circumferentially, the upper shielding cover is fixed to the upper end of the connecting frame by bolts.

7. (canceled)

8. (canceled)

9. The compact neutron generator based on an all-glass helicon wave ion source according to claim 1, wherein an inclined fluoride liquid inlet channel and a horizontal fluoride liquid outflow channel are opened on the side of the high-pressure channel.

10. The compact neutron generator based on an all-glass helicon wave ion source according to claim 1, wherein a coolant of a cooling system of the target part enters through a coolant inlet channel, flows out through a coolant outflow channel, flows through the target base, the target body support rod, the connecting frame and the target, the channels between the target base and the target body support rod, the target support rod and the connecting frame, the connecting frame and the target are water-sealed by sealing rings to prevent the coolant from leaking out.
